(19) United States
(12) Patent Application Publication
(10) Pub. No.: US 2008/0089432 A1
(43) Pub. Date: Apr. 17, 2008

(54) Apparatus and method for beamforming in a multiple-input multiple-output system

(75) Inventors: Sung-Woo Park, Suwon-si (KR); Keun-Chul Hwang, Seongnam-si (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 11/975,061

(22) Filed: Oct. 16, 2007

(30) Foreign Application Priority Data
Oct. 16, 2006 (KR) 2006-0100229

(51) Int. Cl. H04L 27/28

(52) U.S. Cl. 375/260

(57) ABSTRACT

A beamforming apparatus and method in a MIMO system are provided, in which a channel column vector with a highest norm is selected from among channel column vectors of a channel matrix, and a beamforming weight vector being a unitary vector is calculated using the selected channel column vector.

### CROSS-REFERENCE TO RELATED APPLICATION AND CLAIM OF PRIORITY

The present application claims the benefit under 35 U.S.C. § 119(a) of a Korean Patent Application filed in the Korean Intellectual Property Office on Oct. 16, 2006 and assigned Serial No. 2006-0100229, the entire disclosure of which is hereby incorporated by reference.

### TECHNICAL FIELD OF THE INVENTION

The present application generally relates to a multiple-input multiple-output (MIMO) system. More particularly, the present invention relates to an apparatus and method for beamforming.

### BACKGROUND OF THE INVENTION

There are largely three MIMO transmission schemes for a transmitter: beamforming, transmit diversity, and spatial multiplexing. Beamforming offers array gain by forming beams suitable for channels and transmitting them through a plurality of antennas. Transmit diversity achieves diversity gain using a plurality of spatial paths formed by a plurality of antennas. Multiplexing gain can be obtained by transmitting a plurality of data signals simultaneously through a plurality of antennas. This is spatial multiplexing.

A major MIMO reception scheme for a receiver is Maximum Ratio Combining (MRC). The receiver combines signals received through a plurality of antennas according to channels corresponding to the antennas, thus achieving array gain. It is known that the MRC is interference-free and has the best performance for a single antenna. However, when the transmitter uses a MIMO transmission scheme with a plurality of antennas, there may exist a reception scheme according to the MIMO transmission scheme, which outperforms the MRC scheme.

For example, in a system having a transmitter with M transmit antennas and a receiver with N receive antennas, when the transmitter transmits a signal by beamforming, the received signal at the receiver is given as:

$$y = Hbx + n \\ H = [ \begin{matrix}{h}_{I} \\ ⋮ \\ N\end{matrix} ] = [ \begin{matrix}{h}_{II} & ⋯ & {h}_{IM} \\ ⋮ & ⋰ & ⋮ \\ {h}_{NI} & ⋯ & {h}_{NM}\end{matrix} ] , \qquad ( 1 )$$

where y denotes an N×1 received signal vector, x denotes the transmitted signal, H denotes an N×M channel matrix, b denotes an M×1 beamforming weight vector, and n denotes an N×1 noise signal vector.

In this case, an optimal beamforming scheme is eigen beamforming. The eigen-beamforming scheme uses as b an eigenvector corresponding to the highest of eigenvalues obtained by Eigen Value Decomposition (EVD) of a channel correlation matrix H^{H}H expressed as equation (2):

$${H}^{H} H = U Λ {U}^{H} \\ Λ = diag ( {λ}_{I} , ⋯ , {λ}_{min ( M , N )} ) , U = [ {u}_{I} ⋯ {u}_{min ( M , N )} ] \\ b = {u}_{k} , k = {arg max}_{i = I , ⋯ , min ( M , N )} {λ}_{i} \qquad ( 2 )$$

where Λ denotes a diagonal matrix having a predetermined number of eigenvalues λ of the channel correlation matrix as main diagonal entries, U denotes a unitary matrix with a predetermined eigenvectors u, and U^{H} denotes the conjugate complex of the unitary matrix. The predetermined number is defined as the smaller between M and N.

As noted from the above, the receiver needs EVD only when it uses a plurality of antennas. As a result, complexity increases and the other eigenvectors, except for the highest eigenvector, are made obsolete.

In real implementation, a mobile station (MS) with a plurality of antennas usually uses the antennas for transmission but also uses one of antenna for reception due to limitations on power amplification. Referring to FIG. 1, in a MIMO Time Division Duplex (MIMO-TDD) system, for instance, if an MS 101 transmits a signal through a single antenna, a base station (BS) 103 gets only knowledge of a channel vector of the antenna used for both transmission and reception among channel vectors h of the channel matrix H. Therefore, the eigen-beamforming scheme is not viable, which requires full knowledge of all channel vectors.

### SUMMARY OF THE INVENTION

To address the above-discussed deficiencies of the prior art, it is a primary object of the present invention to address at least the problems and/or disadvantages and to provide at least the advantages described below. Accordingly, an aspect of the present invention is to provide an apparatus and method for beamforming in a MIMO system.

Another aspect of the present invention provides an apparatus and method for calculating a beamforming weight vector without a complex process such as EVD when a transmitter transmits a signal by beamforming and a receiver receives a signal through a plurality of receive antennas in a MIMO system.

A further aspect of the present invention provides an apparatus and method for calculating a beamforming weight vector using only a channel vector of one receive antenna when a transmitter does not have full knowledge of all channel vectors in a MIMO system.

Still another aspect of the present invention provides an apparatus and method for achieving an additional performance by combining beamforming with spatial multiplexing in a MIMO system.

In accordance with an aspect of exemplary embodiments of the present invention, there is provided a beamforming apparatus and method in one of a transmitter and a receiver in a MIMO system, in which a channel column vector with a highest norm is selected from among channel column vectors of a channel matrix, and a beamforming weight vector being a unitary vector is calculated using the selected channel column vector.

In accordance with another aspect of exemplary embodiments of the present invention, there is provided a beamforming method in a MIMO system, in which a channel column vector with a highest norm is selected from among channel column vectors of a channel matrix and transmitted to a transmitter by a receiver, and a beamforming weight vector being a unitary vector is calculated using the selected channel column vector by the transmitter.

In accordance with a further aspect of exemplary embodiments of the present invention, there is provided a beamforming apparatus in a MIMO system, in which a receiver selects a channel column vector with a highest norm from among channel column vectors of a channel matrix and transmits the selected channel column vector to a transmitter, and the transmitter calculates a beamforming weight vector being a unitary vector using the selected channel column vector.

In accordance with still another aspect of exemplary embodiments of the present invention, there is provided a beamforming apparatus in a MIMO system, in which one of a transmitter and a receiver selects a channel column vector with a highest norm from among channel column vectors of a channel matrix, and calculates a beamforming weight vector being a unitary vector using the selected channel column vector, and the transmitter multiplies a transmission signal by the beamforming weight vector and transmits the multiplied transmission signal through a predetermined antenna.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of an MS using one transmit antenna in a MIMO-TDD system;

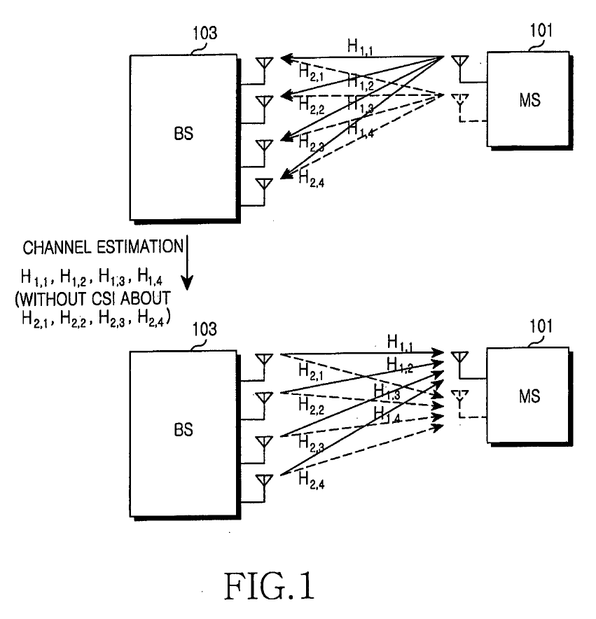

FIG. 2 is a block diagram of a transmitter and a receiver in a MIMO system according to the present invention; and

FIG. 3 is a flowchart of a beamforming method in the MIMO system according to an embodiment of the present invention.

Throughout the drawings, the same drawing reference numerals will be understood to refer to the same elements, features and structures.

### DETAILED DESCRIPTION OF THE INVENTION

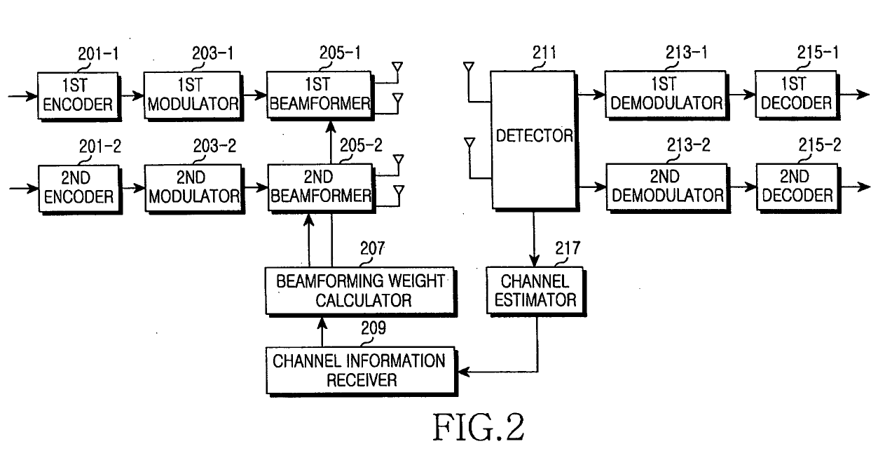

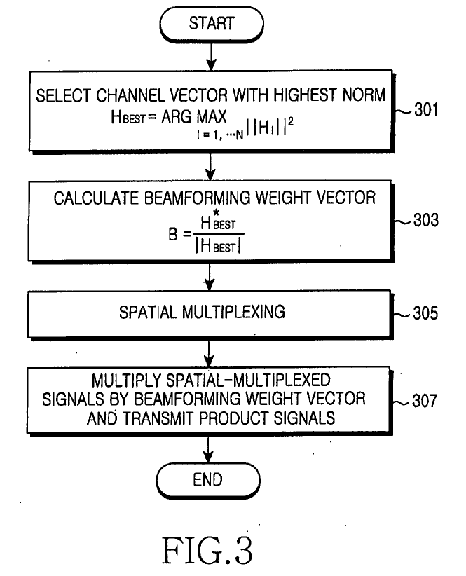

FIGS. 2 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide an apparatus and method for beamforming in a multiple-input, multiple-output (MIMO) system.

FIG. 2 is a block diagram of a transmitter and a receiver in a MIMO system according to the present invention. While it is described that the MIMO system has a transmitter with four transmit antennas and a receiver with two receive antennas, this is merely an exemplary application. Hence, it is to be clearly understood that the same description applies to a MIMO system having a transmitter with M transmit antennas and a receiver with N receive antennas. The transmitter includes first and second encoders 201-1 and 201-2, first and second modulators 203-1 and 203-2, first and second beamformers 205-1 and 205-2, a beamforming weight calculator 207, and a channel information receiver 209. The receiver includes a detector 211, first and second demodulators 213-1 and 213-2, first and second decoders 215-1 and 215-2, and a channel estimator 217.

Referring to FIG. 2, in the transmitter, the first and second encoders 201-1 and 201-2 encode input signals at predetermined coding rates. The encoders 201-1 and 201-2 can be convolutional encoders, turbo encoders, or Low Density Parity Check (LDPC) encoders.

The first and second modulators 203-1 and 203-2 modulate the code symbols received from their connected encoders 201-1 and 201-2 in predetermined modulation schemes such as binary phase shift keying (BPSK), quadrature phase shift keying (QPSK), 8-ary Quadrature Amplitude Modulation (8QAM), or 16-ary QAM (16QAM). One bit (s=1) is mapped to one complex signal in BPSK, two bits (s=2) to one complex signal in QPSK, three bits (s=3) to one complex signal in 8QAM, and four bits (s=4) to one complex signal in 16QAM.

The first and second beamformers 205-1 and 205-2 spatially multiplex the modulation symbols received from their connected modulators 203-1 and 203-2 according to the numbers of their connected antennas, multiply the spatially multiplexed signals by a beamforming weight vector received from the beamforming weight calculator 207, and output the product signals through predetermined antennas. That is, the first and second beamformers 205-1 and 205-2 form transmission beams using the beamforming weight vector and transmits the signals in the directions of the transmission beams.

The beamforming weight calculator 207 receives channel information from the channel information receiver 209, selects a channel column vector with the highest norm among the channel vectors h of a channel matrix H, calculates the beamforming weight vector using the selected channel column vector, and outputs the beamforming weight vector to the first and second beamformers 205-1 and 205-2.

The channel information receiver 209 outputs the channel information received from the channel estimator 217 of the receiver to the beamforming weight calculator 207.

Meanwhile, in the receiver, the detector 211 detects received symbols from signals received through the receive antennas.

The first and second demodulators 213-1 and 213-2 demodulate the received symbols in predetermined demodulation methods.

The first and second decoders 215-1 and 215-2 decode the demodulated symbols received from their connected demodulators 213-1 and 213-2 at predetermined decoding rates, thereby recovering original signal.

The channel estimator 217 estimates channels using the received signals and feeds back the estimated channel information to the channel information receiver 209 of the transmitter.

FIG. 3 is a flowchart of a beamforming method in the MIMO system according to an embodiment of the present invention. In the illustrated case of FIG. 3, the MIMO system includes a transmitter with M transmit antennas and a receiver with N receive antennas.

Referring to FIG. 3, the transmitter selects a channel column vector h_{best} with the highest norm in a channel matrix H by equation (3) to calculate a beamforming weight vector b in step 301 as:

$${h}_{best} = {arg max}_{i = I , ⋯ , N} {‖ {h}_{i} ‖}^{2} , \qquad ( 3 )$$

where hᵢ denotes a 1×M channel vector between an i^{th} receive antenna and the M transmit antennas.

In step 303, the transmitter calculates the beamforming weight vector b using the selected channel column vector h_{best} with the highest norm by:

$$b = \frac{{h}_{best}^{*}}{‖ {h}_{best} ‖} , \qquad ( 4 )$$

where * represents conjugate transpose and h_{best}* is divided by ∥h_{best}∥ so that b becomes a unitary vector and thus a beamforming-caused power increase is avoided. If the transmitter has knowledge only of a channel vector of receive antenna 1, it can calculate the beamforming weight vector b using a channel column vector h₁ instead of h_{best}. In this manner, the transmitter can calculate the beamforming weight vector b with knowledge only of a channel vector of one receive antenna as well as with full knowledge of all channel vectors.

For example, for a system with M=2 and N=2, when ∥h₁∥²>∥h₂∥² or the transmitter knows only h₁, b=h₁*/∥h₁∥. Then the received signal is given as:

$$[ \begin{matrix}{y}_{I} \\ {y}_{2}\end{matrix} ] = [ \begin{matrix}{h}_{I} \\ {h}_{2}\end{matrix} ] \cdot \frac{{h}_{I}^{*}}{‖ {h}_{I} ‖} \cdot x + [ \begin{matrix}{n}_{I} \\ {n}_{2}\end{matrix} ] . \qquad ( 5 )$$

Equation (5) can be expressed as:

$${y}_{I} = ‖ {h}_{I} ‖ x + {n}_{1} \\ {y}_{2} = \frac{{h}_{2} + {h}_{I}^{*}}{‖ {h}_{I} ‖} x + {n}_{2} . \qquad ( 6 )$$

It can be noted that a beamforming-incurred array gain can perfectly be achieved for the signal received through receive antenna 1, y₁. If the receive antennas are sufficiently spaced from each other and h₁ is perfectly independent of h₂, h₁*/∥h₁∥ is a unitary vector. Thus, the signal received through receive antenna 2, y₂ has the same performance as when:

y₂=ĥx+n₂(E[|ĥ|²]=E[|h_{2,1}|²]=E[|h_{2,2}|²]).

That is, combining y₁ with y₂ brings a 1×1 additional power and diversity gain by y₂ as well as a 2×1 antenna array gain by y₁. If the receive antennas are close to each other and h₂h₁*/∥h₁∥ becomes approximate to ∥h₁∥, a partial array gain can be achieved additionally. That is, this beamforming scheme is a robust one that offers a sufficient gain by a simple computation without a complex process like EVD and a gain irrespective of whether the correlation between the transmit antennas is high or low.

In step 305, the transmitter spatially multiplexes the transmission signal to M signals, M being the number of the transmit antennas. The transmitter then multiplies the spatially multiplexed signals by the beamforming weight vector b and transmits the product signals through predetermined transmit antennas in step 307. That is, the transmitter forms transmission beams using the beamforming weight vector b and transmits the signals in the directions of the transmission beams. The transmitter then ends the algorithm of the present invention.

With the additional use of spatial multiplexing, the signal received through antenna 2 gets an additional spatial multiplexing gain as well as the afore-mentioned gain. In a system where an MS has two antennas and a BS transmits two streams by spatial multiplexing, if the BS uses four transmit antennas, the two streams are transmitted through the four transmit antennas by Cyclic Delay Diversity (CDD) in compliance with Institute of Electrical and Electronics Engineers (IEEE) 802.16e. Although CDD provides only diversity gain, it can achieve an additional array gain by transmission of the two streams through the four antennas by the proposed beamforming scheme.

For 4×2 channels, the conventional eigen-beamforming scheme selects one best eigen mode and transmits one stream in the best eigen mode, thus achieving a full array gain without a spatial multiplexing gain. A similar scheme called Singular Value Decomposition (SVD) selects two eigen modes and transmits two streams in the two eigen modes. This SVD scheme has an additional spatial multiplexing gain but suffers from an increased complexity. The beamforming method of the present invention offers a beamforming-incurred array gain by a first receive antenna without a complex process such as EVD and SVD, and a spatial multiplexing gain by a second receive antenna. Since a beamforming weight vector can be calculated using only a channel vector of a single receive antenna, the beamforming method facilitates real implementation.

While the transmitter selects the channel column vector h_{best} with the highest norm in the channel matrix H in step 301 and calculates the beamforming weight vector b using h_{best} in step 305, it can further be contemplated as another embodiment of the present invention that steps 301 and 305 take place in the receiver. That is, the receiver estimates channels using a received signal, selects the channel column vector h_{best} with the highest norm in the channel matrix H using the estimated channel information, calculates the beamforming weight vector b using h_{best}, and feeds back b to the transmitter. The transmitter then multiplies transmission signals by b, prior to transmission through predetermined transmit antennas.

A third embodiment of the present invention can be contemplated, in which the receiver selects the channel column vector h_{best} with the highest norm in the channel matrix H in step 301 and the transmitter calculates the beamforming weight vector b using h_{best} in step 305. That is, the receiver estimates channels using a received signal, selects the channel column vector h_{best} with the highest norm in the channel matrix H using the estimated channel information, and feeds back h_{best} to the transmitter. The transmitter then calculates the beamforming weight vector b using h_{best} and multiplies transmission signals by b, prior to transmission through predetermined transmit antennas.

As is apparent from the above description, the present invention provides an apparatus and method for calculating a beamforming weight vector using only a channel vector of one receive antenna without a complex process such as EVD or SVD, when a receiver uses a plurality of receive antennas and a transmitter transmits signals by beamforming in a MIMO system. Therefore, the transmitter can calculate the beamforming weight vector without full knowledge of all channel vectors. Also, combining the beamforming scheme with spatial multiplexing produces a spatial multiplexing gain as well as an array gain. Thus, an additional performance is achieved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A beamforming method in one of a transmitter and a receiver in a multiple-input multiple-output (MIMO) system, comprising:
selecting a channel column vector with a highest norm from among channel column vectors of a channel matrix; and
calculating a beamforming weight vector being a unitary vector using the selected channel column vector.

2. The beamforming method of claim 1, wherein the selection comprises selecting the channel column vector by equation (7),
$${h}_{best} = {arg max}_{i = I , ⋯ , N} {‖ {h}_{i} ‖}^{2} \qquad ( 7 )$$
where h_{best} denotes the selected channel column vector, hᵢ denotes a 1×M channel vector between an i^{th} receive antenna among N receive antennas and M transmit antennas.

3. The beamforming method of claim 1, wherein the calculation comprises calculating the beamforming weight vector by equation (8),
$$b = \frac{{h}_{best}^{*}}{‖ {h}_{best} ‖} \qquad ( 8 )$$
where b denotes the beamforming weight vector, h_{best} denotes the selected channel column vector, and * represents conjugate transpose.

4. The beamforming method of claim 1, further comprising acquiring the channel matrix by channel estimation.

5. The beamforming method of claim 4, further comprising transmitting the calculated beamforming weight vector to the transmitter.

6. The beamforming method of claim 1, further comprising receiving channel information from the receiver and acquiring the channel matrix based on the channel information.

7. The beamforming method of claim 6, further comprising multiplying a transmission signal by the beamforming weight vector and transmitting the multiplied transmission signal through a predetermined antenna.

8. The beamforming method of claim 7, wherein the transmission signal is as many spatially multiplexed signals as the number of antennas.

9. A beamforming method in a multiple-input multiple-output (MIMO) system, comprising:
selecting a channel column vector with a highest norm from among channel column vectors of a channel matrix and transmitting the selected channel column vector to a transmitter by a receiver; and
calculating a beamforming weight vector being a unitary vector using the selected channel column vector by the transmitter.

10. The beamforming method of claim 9, wherein the selection comprises selecting the channel column vector by equation (9),
$${h}_{best} = {arg max}_{i = I , ⋯ , N} {‖ {h}_{i} ‖}^{2} \qquad ( 9 )$$
where h_{best} denotes the selected channel column vector, hᵢ denotes a 1×M channel vector between an i^{th} receive antenna among N receive antennas and M transmit antennas.

11. The beamforming method of claim 9, wherein the calculation comprises calculating the beamforming weight vector by equation (10),
$$b = \frac{{h}_{best}^{*}}{‖ {h}_{best} ‖} \qquad ( 10 )$$
where b denotes the beamforming weight vector, h_{best} denotes the selected channel column vector, and * represents conjugate transpose.

12. The beamforming method of claim 9, further comprising acquiring the channel matrix by channel estimation by the receiver.

13. The beamforming method of claim 9, further comprising multiplying a transmission signal by the beamforming weight vector and transmitting the multiplied transmission signal through a predetermined antenna by the transmitter.

14. The beamforming method of claim 13, wherein the transmission signal is as many spatially multiplexed signals as the number of antennas.

15. A beamforming apparatus in a multiple-input multiple-output (MIMO) system, comprising:
a receiver for selecting a channel column vector with a highest norm from among channel column vectors of a channel matrix and transmitting the selected channel column vector to a transmitter; and
the transmitter for calculating a beamforming weight vector being a unitary vector using the selected channel column vector.

16. The beamforming apparatus of claim 15, wherein the receiver selects the channel column vector by equation (11),
$${h}_{best} = {arg max}_{i = I , ⋯ , N} {‖ {h}_{i} ‖}^{2} \qquad ( 11 )$$
where h_{best} denotes the selected channel column vector, hᵢ denotes a 1×M channel vector between an i^{th} receive antenna among N receive antennas and M transmit antennas.

17. The beamforming apparatus of claim 15, wherein the transmitter calculates the beamforming weight vector by equation (12),
$$b = \frac{{h}_{best}^{*}}{‖ {h}_{best} ‖} \qquad ( 12 )$$
where b denotes the beamforming weight vector, h_{best} denotes the selected channel column vector, and * represents conjugate transpose.

18. The beamforming apparatus of claim 15, wherein the transmitter multiplies a transmission signal by the beamforming weight vector and transmits the multiplied transmission signal through a predetermined antenna.

19. A beamforming apparatus in a multiple-input multiple-output (MIMO) system, comprising:
one of a transmitter and a receiver for selecting a channel column vector with a highest norm from among channel column vectors of a channel matrix, and calculating a beamforming weight vector being a unitary vector using the selected channel column vector; and
the transmitter for multiplying a transmission signal by the beamforming weight vector and transmitting the multiplied transmission signal through a predetermined antenna.

20. The beamforming apparatus of claim 19, wherein the one of the transmitter and the receiver selects the channel column vector by equation (13),
$${h}_{best} = {arg max}_{i = I , ⋯ , N} {‖ {h}_{i} ‖}^{2} \qquad ( 13 )$$
where h_{best} denotes the selected channel column vector, hᵢ denotes a 1×M channel vector between an i^{th} receive antenna among N receive antennas and M transmit antennas.

21. The beamforming apparatus of claim 19, wherein the one of the transmitter and the receiver calculates the beamforming weight vector by equation (14),
$$b = \frac{{h}_{best}^{*}}{‖ {h}_{best} ‖} \qquad ( 14 )$$
where b denotes the beamforming weight vector, h_{best} denotes the selected channel column vector, and * represents conjugate transpose.

22. The beamforming apparatus of claim 19, wherein if the one of the transmitter and the receiver is the receiver, the receiver acquires the channel matrix by channel estimation, and if the one of the transmitter and the receiver is the receiver, the transmitter receives channel information from the receiver and acquires the channel matrix based on the channel information.

23. The beamforming apparatus of claim 19, wherein if the one of the transmitter and the receiver is the receiver, the receiver transmits the calculated beamforming weight vector to the transmitter.

24. The beamforming apparatus of claim 19, wherein the transmitter spatially multiplexes the transmission signal to as many signals as the number of antennas before multiplying the transmission signal by the beamforming weight vector.
